(19) United States
(12) Patent Application Publication
(10) Pub. No.: US 2015/0260088 A1
(43) Pub. Date: Sep. 17, 2015

(54) INTAKE/OUTLET PIPE OPTIMIZATION METHOD FOR ROTARY ENGINE

(71) Applicant: Chung-Shan Institute of Science and Technology, Armaments Bureau, M.N.D, Taoyuan County (TW)

(72) Inventors: Dun-Zen Jeng, Taoyuan County (TW); Ming-Chun Hsieh, Taoyuan County (TW); Chih-Chuan Lee, Taoyuan County (TW); Ting-Hua Chieh, Taoyuan County (TW)

(73) Assignee: Chung-Shan Institute of Science and Technology, Armaments Bureau, M.N.D, Taoyuan County (TW)

(21) Appl. No.: 14/212,773

(22) Filed: Mar. 14, 2014

(51) Int. Cl. F02B 53/04; F04C 15/06; F02B 55/02

(52) U.S. Cl. CPC F02B 53/04; F02B 55/02; F04C 15/06

(57) ABSTRACT

An intake/outlet pipe optimization method and apparatus for a rotary engine are disclosed. The method includes the steps of providing a rotary engine, measuring the pressure in an operation of the engine, designing the appearance of the intake/outlet pipes, adjusting the pressure wave in an air pipe and the pressure in an air chamber of the engine to increase the air intake and improve the output horsepower of the engine. The intake pipe is a tapered pipe having the pipe diameter on an intake side greater than the pipe diameter on the engine side; and the outlet pipe is an inversely tapered pipe having the pipe diameter on the engine side smaller than the pipe diameter on the outlet side.

### BACKGROUND OF THE INVENTION

1. Field of Invention

The present invention relates to an intake/outlet pipe optimization method for a rotary engine and an apparatus thereof, and particularly to the method and apparatus that control the length, diameter and shape of the intake pipe and outlet pipe, so that the pressure of the air pipes is corresponsive to the pressure of an air chamber of the engine to enhance the engine power.

2. Description of Related Art

In general, a conventional rotary engine has the advantages of high power-to-weight ratio, small volume, fewer components, and compact structure, and the intake and outlet pipes of the engine are smooth pipes The engine divides a cylinder into three air chambers by a triangular rotor. When the rotor rotates a round, the three air chambers can complete a cycle including air intake, compression, combustion and exhaust to produce a power output. When the air in the air chamber encounters a spark, the combustion takes place quickly, and the generated heat energy drives the air to produce a strong pressure and output a power. Factors affecting the performance of the engine include intake and exhaust timing arrangement, ignition time, cylinder volume, air-fuel ratio, etc. Unlike a general piston engine that can control the intake and exhaust timing by adjusting the intake/exhaust valves to achieve an optimized status, the power output of the rotary engine is confined to the arrangement of its fixed geometric appearances and cannot be changed without hardware modification.

In general, the intake status is related to the pressure difference between the intake pipe and the air-intake chamber. In the intake stage of an engine, the more the fresh air, the better. Therefore, the pressure of the intake pipe is better at a higher level than that of the air chamber, so that the air from the intake pipe can enter into the air chamber. On the other hand, if the pressure is higher in the air chamber than the intake pipe, the air in the chamber will flow reversely into the intake pipe, meaning that the air intake process temporarily stops, or even more the air flows out from the intake pipe, and thus resulting in an insufficient air intake.

At present, most of the methods of enhancing the engine performance emphasizes on the appearance of the combustion chamber or the ignition timing, and thus incurring a higher cost and a longer time for modifying the engine body or using an additional turbocharger to provide a higher inlet pressure and a greater air intake to enhance the performance. However, a too-high pressure in the intake pipe will increase the fuel consumption rate, and a portion of fuel gas is discharged from the outlet pipe, and thus failing to comply with the economic and environmental protection requirements.

### SUMMARY OF THE INVENTION

In view of the shortcomings of the prior art, it is a primary objective of the present invention to overcome the shortcomings by providing an intake/outlet pipe optimization method for a rotary engine, wherein the pressure wave in the intake pipe together with the pressure in the air chamber of the rotary engine are adequately adjusted by the appearance alternation of the intake/outlet pipe to improve the air intake status of the engine and enhance the performance. Without changing the design of engine body, the shape, length and diameter of the intake/outlet pipe can be adjusted. Compared with the conventional straight intake/outlet pipe, the shape of the intake pipe of the invention is tapered to adjust the pressure of the air pipe and increase the air intake, so as to enhance the engine power.

After the exhaust air in the chamber is discharged, the volume of that chamber is gradually increasing, and the engine is situated at a negative pressure status (less than ambient pressure) and starts the air intake process. The pressure of the intake pipe is greater than the negative pressure of the chamber, so that the air in the intake pipe can flow into the air chamber. As the chamber volume is about to reach the maximum and start the compression process, the pressure rises and slows down the chamber air-intake process, and the inertia of airflow in the intake pipe builds up higher pressure at the engine side. The negative pressure in the chamber as well as the high pressure in the intake pipe during the air-intake process will travel along the pipe to the other end, ambient end or engine port end, and reflect backward to form pressure wave motion in the pipe. Pipe wave motion has significant influence on the air-intake process. If the intake pipe pressure stays at a higher level while the chamber is in a negative pressure condition, it will be beneficial for air intake. To take advantages of this, the pressure wave motion in the intake pipe that goes with some certain frequency and amplitude at a specific rotational speed can be changed by the geometric feature of the air intake pipe.

To achieve the aforementioned objective, the present invention provides an intake/outlet pipe optimization method for a rotary engine, and the method comprises the following steps:

(A) Provide a rotary engine body. (S10)

(B) Run the rotary engine at a specific rotational speed, and measure the instantaneous pressure for both air intake pipe and the chamber (S20)

(C) Control the shape of an intake or outlet pipe with a taper angle, such that the pipe diameter is greater on the intake side than on the engine side. (S30)

(D) Perform a series of engine performance tests on variations of the pipe length, pipe diameter, and pipe shape, and determine optimal combinations of the pipe length, pipe diameter and pipe shape by the test results. (S40)

Wherein, the shape of the intake/outlet pipe has a taper angle from the ambient side to the engine side. From the air flow direction point of view, the shape of intake pipe has a relatively lager cross-section area at upstream, ambient side. Reversely, the shape of the outlet pipe has a relatively smaller cross-section area at the upstream, the engine side.

The alternation of the pipe taper angle is ranged from 0 degree to 50 degrees with several intervals in between. The pipe length range is from 100 mm to 1500 mm with several intervals in between.

Through Different combinations of the pipe length, pipe diameter, and pipe shape described in the step (D) to adjust the amplitude and frequency of the pressure wave in the intake pipe in accordance with the instantaneous chamber pressure, the engine can be situated at a proper or better air intake status, and the mass of air intake will be increased to enhance the performance.

Another objective of the present invention is to provide an intake/outlet pipe optimization apparatus for a rotary engine, and the apparatus comprises: a rotary engine body, including an intake pipe coupled to engine intake port, and an outlet pipe coupled to the engine outlet port, so that the air flows into the intake pipe to the engine body and then chemical reactions through combustion to produce work, and exhaust gas is discharged from the outlet pipe to the ambient; wherein the end connecting the pipe with the engine body is an engine side, and the other end an intake side

Wherein, the design of the intake pipe or the outlet pipe is the same as that of the aforementioned intake/outlet pipe optimization method for a rotary engine, and the pressure wave motion in the pipe is adjusted by the pipe length, pipe diameter, and pipe shape to achieve a better air intake condition.

Wherein, the pipe shape of the intake pipe or the outlet pipe is in form of a segmented or continuous curve, and these pipes are substantially conical pipes.

### BRIEF DESCRIPTION OF THE DRAWINGS

FIG. 1 is a flow chart of an intake/outlet pipe optimization method for a rotary engine in accordance with the present invention;

FIG. 2 is a schematic view of an intake/outlet pipe optimization apparatus for a rotary engine in accordance with the present invention;

FIG. 3 is a schematic view showing the shape and angle of an intake/outlet pipe of a rotary engine of the present invention; and

FIG. 4 is a schematic view of an intake/outlet pipe optimization apparatus in accordance with a preferred embodiment of the present invention.

### DETAILED DESCRIPTION OF THE INVENTION

The technical characteristics and objectives of the present invention can be further understood by the following detailed description of preferred embodiments and related drawings.

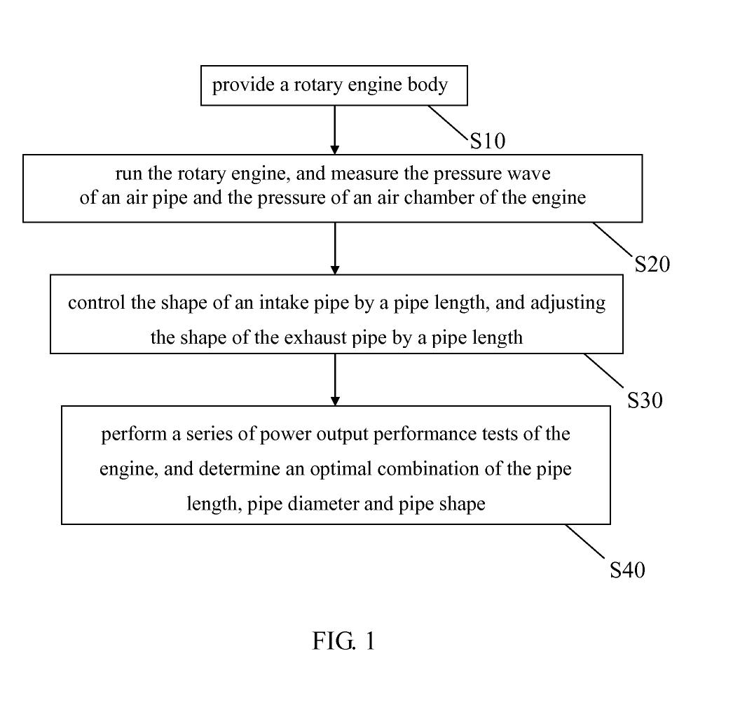

With reference to FIG. 1 for the flow chart of an intake/outlet pipe optimization method for a rotary engine in accordance with the present invention, the method comprises the following steps:

(A) Provide a rotary engine body. S10

(B) Run the rotary engine, and measure the instantaneous pressure for both the air intake pipe and the air chamber of the engine. S20

(C) Control the shape of an intake pipe over a certain pipe length, such that the pipe diameter on an intake side is greater than the pipe diameter on the engine side, and control the shape of the outlet pipe over a certain pipe length, such that the pipe diameter on the engine side is smaller than the pipe diameter on an outlet side. S30

(D) Perform a series of engine performance tests according to different combinations of the pipe length, pipe diameter, pipe shape, and determine optimal combinations of the pipe length, pipe diameter and pipe shape by the engine performance test results. S40

The pressure wave of the intake pipe and the outlet pipe and the pressure of the air chamber of the engine are adjusted according to the aforementioned method to achieve smooth air intake and exhaust by the intake/outlet pipe optimization apparatus for a rotary engine, so as to increase the air intake and provide smooth intake and exhaust for the engine, so as to enhance the performance of the rotary engine.

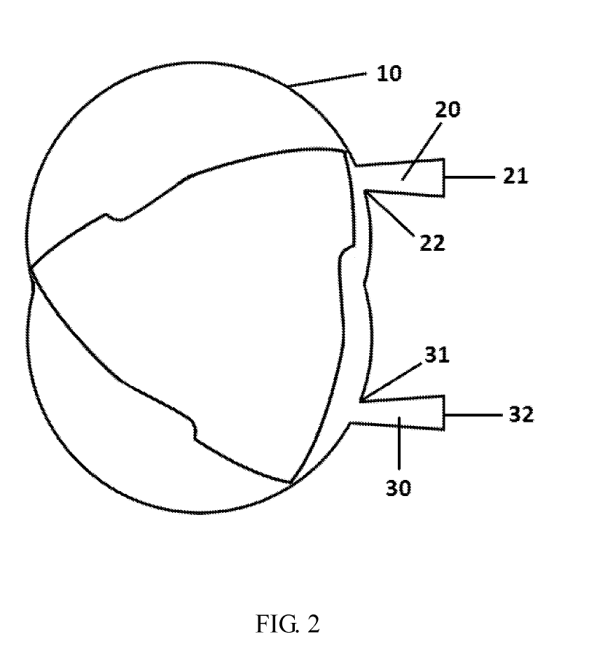

With reference to FIG. 2 for a schematic view of an intake/outlet pipe optimization apparatus for a rotary engine in accordance with the present invention, the apparatus comprises: a rotary engine body 10, an intake pipe 20 and an outlet pipe 30, wherein the intake pipe 20 is a tapered conical pipe having an air intake side 21 and an engine side 22, and the outlet pipe 30 an inversely tapered conical pipe having an engine side 31 and an outlet side 32. The intake pipe 20 is coupled to the engine side 22 of the rotary engine body 10, and the outlet pipe 30 is coupled to the engine side 31 of the rotary engine body 10, so that after air enters from the intake pipe 20 into the rotary engine body 10 to produce power, a waste gas is discharged from the outlet pipe 30.

### Preferred Embodiment 1

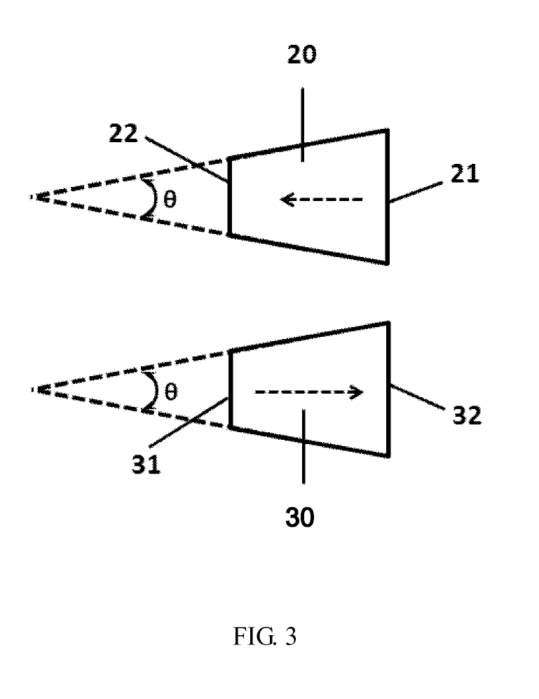

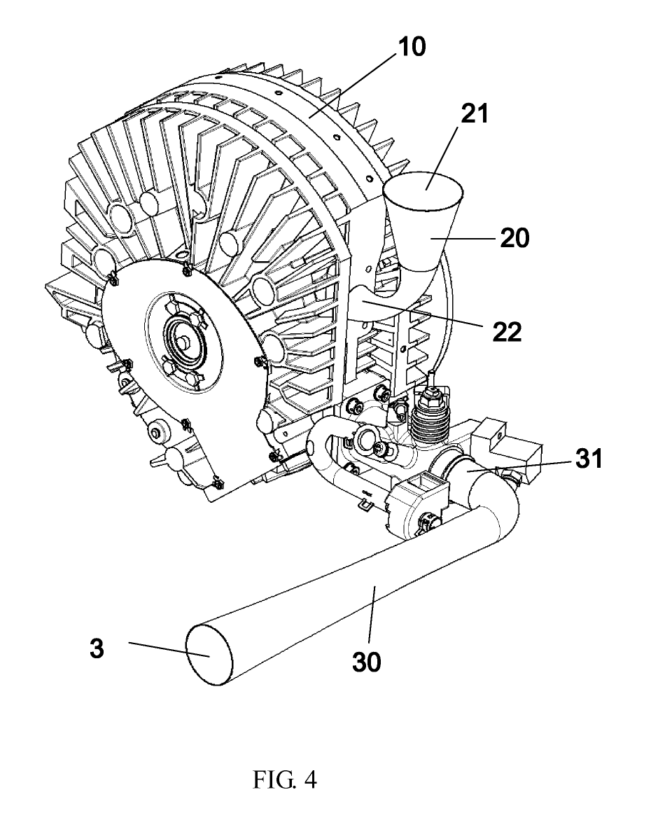

With reference to FIGS. 3 and 4 for a schematic view showing the shape and angle of an intake/outlet pipe of a rotary engine of the present invention and a schematic view of an intake/outlet pipe optimization apparatus in accordance with a preferred embodiment of the present invention respectively, a rotary engine body 10 is provided, and the engine supplies a power of 32 horsepower with original intake/outlet (approximately equal to 22.37 KW) at 6800 revolutions per minute (rpm). The outlet pipe 30 geometry is fixed in length, diameter and pipe shape. The tapered intake pipe 20 has a pipe diameter of 31.5 mmat the engine side, 8-degree pipe taper angle, a pipe length variation from 50 mm-1000 mm, and an engine performance test is conducted to obtain a test result showing that the length of the intake pipe can affect the engine performance and peak at around 700 mm in length about 16.8%.

### Preferred Embodiment 2

A rotary engine body 10 is provided, and the engine supplies a power of approximately 32 hp. Under a rotation speed of 6800 revolutions per minute (rpm), the pipe length, pipe diameter and pipe shape of the inversely tapered outlet pipe 30 are fixed, and the intake pipe 20 has a pipe length of 400 mm, a constant pipetaper angle of 2 degrees, and pipe diameter variation from 25 mm-40 mm at the engine side, and an engine performance test is conducted to obtain a test result showing that the diameter of the intake pipe can affect the engine performance and peak the output power by 16.9% at 35 mm in diameter.

Therefore, the engine performance can be enhanced by a design that optimizes the pipe length, pipe diameter and pipe shape of the intake/outlet pipe to provide a combination of the optimal pipe length, pipe diameter and pipe shape for various intake/outlet pipes of the engine. The invention can improve the performance of an engine over the conventional engine with the same horsepower output.

While the invention has been described by means of specific embodiments, numerous modifications and variations could be made thereto by those skilled in the art without departing from the scope and spirit of the invention set forth in the claims.

What is claimed is:

1. An intake/outlet pipe optimization method for a rotary engine, comprising the steps of:
(A) providing a rotary engine body;
(B) running the rotary engine, and measuring the pressure of an air pipe and the pressure of an air chamber of the engine;
(C) controlling a pipe shape of the intake pipe by pipe length, such that the pipe diameter on an intake side is greater than the pipe diameter on an engine side, and controlling the pipe shape of an outlet pipe by a pipe length, such that the pipe diameter on the engine side is smaller than the pipe diameter on an outlet side; and
(D) performing a series of power output performance tests of the engine according to different combinations of the pipe length, pipe diameter, pipe shape and pipe angle, and determining an optimal combination of the pipe length, pipe diameter and pipe shape by an engine performance test result.

2. The method of claim 1, wherein the pipe shape of the intake pipe is a tapered pipe shape, and the airflow direction is from the intake side with a relatively larger cross-sectional area to the engine side with a relatively smaller cross-sectional area.

3. The method of claim 1, wherein the pipe shape of the outlet pipe is a tapered pipe shape, and the airflow direction is from the engine side with a relatively larger cross-sectional area to the outlet side with a relatively smaller cross-sectional area.

4. The method of claim 1, wherein the pipe shape of the intake pipe and the pipe shape of the outlet pipe control the taper angle of the air pipe, and the angle is an included angle between an open end of the air pipe and the engine side.

5. The method of claim 4, wherein the pipe angle control range is from 0 degree to 50 degrees, and the angles have values with an interval from one another.

6. The method of claim 1, wherein the pipe length control range is from 100 mm to 1500 mm, and the pipe lengths have values with an interval from one another.

7. The method of claim 1, wherein different combinations of the pipe length, pipe diameter, and pipe shape described in the step (D) together with the pressure of the air chamber of the rotary engine are provided for adjusting the amplitude and frequency of the pressure wave in the intake pipe, so that when the engine is situated at an air intake status, the pressure of the intake pipe is greater than the pressure of the air chamber.

8. An intake/outlet pipe optimization apparatus for a rotary engine, comprising:
a rotary engine body, including an intake pipe coupled to an intake side of the engine body, and an outlet pipe coupled to an outlet side of the engine body, so that after air is entered from the intake pipe to the engine body to produce power, a waste gas is discharged from the outlet pipe;
wherein an end connecting the intake pipe with the engine body is an engine side, and the other end of the intake pipe communicated with the ambient is an air intake side, and the pipe shape of the intake pipe is adjusted by a pipe length, so that the pipe diameter of the air intake side is greater than the pipe diameter of the engine side; and
an end connecting the outlet pipe with the engine body is an engine side, and the other end of the outlet pipe communicated with the ambient is an outlet side, and the pipe shape of the outlet pipe is adjusted by a pipe length, so that the pipe diameter of the engine side is smaller than the pipe diameter of the outlet side, and the pressure wave in the pipe and the pressure of the air chamber are adjusted to increase the air intake by the pipe diameter, pipe length and pipe shape of the intake pipe and the outlet pipe to provide smooth intake and exhaust of the air and enhance the horsepower output of the rotary engine.

9. The apparatus of claim 8, wherein the pipe shape of the intake pipe is a tapered pipe shape, and the airflow direction is from the intake side with a relatively larger cross-sectional area to the engine side with a relatively smaller cross-sectional area.

10. The apparatus of claim 8, wherein the pipe shape of the outlet pipe is a tapered pipe shape, and the airflow direction is from the engine side with a relatively larger cross-sectional area to the outlet side with a relatively smaller cross-sectional area.

11. The apparatus of claim 8, wherein the pipe shape of the intake pipe and the outlet pipe controls an angle of the air pipe, and the angle is an included angle between an open end of the air pipe and the engine side.

12. The apparatus of claim 8, wherein the pipe shape of the intake pipe and the outlet pipe is in form of a segmented or continuous camber.

13. The apparatus of claim 8, wherein the combination of the pipe length, pipe diameter and pipe shape of the intake pipe and the outlet pipe is formed according to the optimization method of claim 1.
